(19) United States
(12) Patent Application Publication
(10) Pub. No.: US 2022/0201359 A1
(43) Pub. Date: Jun. 23, 2022

(54) A DEVICE, COMPUTER PROGRAM AND METHOD

(71) Applicant: SONY GROUP CORPORATION, Tokyo (JP)

(72) Inventors: Robert Mark Stefan PORTER, Basingstoke (GB); Jian-Rong CHEN, Basingstoke (GB); Richard COOPER, Basingstoke (GB)

(73) Assignee: SONY GROUP CORPORATION, Tokyo (JP)

(21) Appl. No.: 17/600,441

(22) PCT Filed: Mar. 20, 2020
(86) PCT No.: PCT/GB2020/050753

§ 371 Date: Sep. 30, 2021

(30) Foreign Application Priority Data
Apr. 8, 2019 (GB) 1904951.9

(51) Int. Cl. H04N 21/442; H04N 21/61; H04N 21/4402; H04N 21/647

(52) U.S. Cl. CPC H04N 21/44209; H04N 21/64723; H04N 21/4402; H04N 21/6125

(57) ABSTRACT

A method of monitoring a network having a first and second device, comprising: receiving IP packets containing media content from the first device on the network, the IP packets being sent to the second device; analysing the received IP packets to determine a parameter of the media content; analysing the parameter of the media content and a parameter associated with the second device; and performing a predetermined action in the event of that the parameter of the media content is different to the parameter associated with the second device.

### BACKGROUND

### Field of the Disclosure

The present technique relates to a device, computer program and method.

### Description of the Related Art

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present technique.

Pro-Audio/Video systems (Pro-AV systems) increasingly use Internet Protocol (IP) Packets to communicate Audio/Video (AV) data between devices. This is because existing infrastructure may be used, thus reducing the cost in implementing such systems.

In order to convert the AV data into IP packets, devices called AV over IP devices are sometimes used. These devices convert the AV data into IP packets which are then distributed over an Ethernet network, or convert IP data received from a network into AV data.

The distribution of the IP packets (such as defining the sources and destination of the packets) is controlled using a management system. However, the inventors have identified a problem with existing systems.

As the size of networks increase, and as networks include different types of devices, the inventors have identified one or more improvements that can be made to management systems.

In particular, whilst management systems can set up a forwarding path between devices, the physical capacity of the network over which the IP packets are passed may not be able to physically route the IP packets. Moreover, with many devices being “plug-n-play” type devices where settings are automatically configured when the device is connected to the network, there is an increased risk of AV data being sent as IP packets to multiple devices in a format or at a resolution not supported by one or more of the devices or in a format or resolution that is not of the highest available quality that the receiving device supports.

It is an aim of the present disclosure to address one or more of these issues.

### SUMMARY

According to embodiments of the disclosure, there is provided a method of monitoring a network having a first and second device, comprising: receiving IP packets containing media content from the first device on the network, the IP packets being sent to the second device; analysing the received IP packets to determine a parameter of the media content; analysing the parameter of the media content and a parameter associated with the second device; and performing a predetermined action in the event of that the parameter of the media content is different to the parameter associated with the second device. Other embodiments and features of the disclosure are defined in the claims.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 shows a block diagram showing a network 100 to which embodiments of the disclosure are applied;

FIG. 2 shows a data structure associated with each device on the network stored within the storage 155 of the monitoring device 150;

FIG. 3 shows a flow chart 500 explaining an initial network function monitoring carried out by the monitoring device 150;

FIG. 4 shows a flow chart according to embodiments;

FIG. 5 shows a time line explaining a problem

FIG. 6 shows a time line explaining where a situation where the problem of FIG. 5 does not occur

FIG. 7 shows a flow chart explaining the monitoring of broadcast traffic by monitoring device 150;

FIG. 8 shows a flow chart explaining a mechanism for identifying if a converter or its connected AV device is not operating correctly;

FIG. 9 shows a flow chart 900 explaining the analysis of video format conversions according to embodiments;

FIG. 10 shows a flow chart describing embodiments of the disclosure;

FIGS. 11a to 11c shows a chart assisting a user to visualise a problem with the network and

FIGS. 12a and 12b show a User interface assisting a user to visualise a problem with the network.

### DESCRIPTION OF THE EMBODIMENTS

Referring now to the drawings, wherein like reference numerals designate identical or corresponding parts throughout the several views.

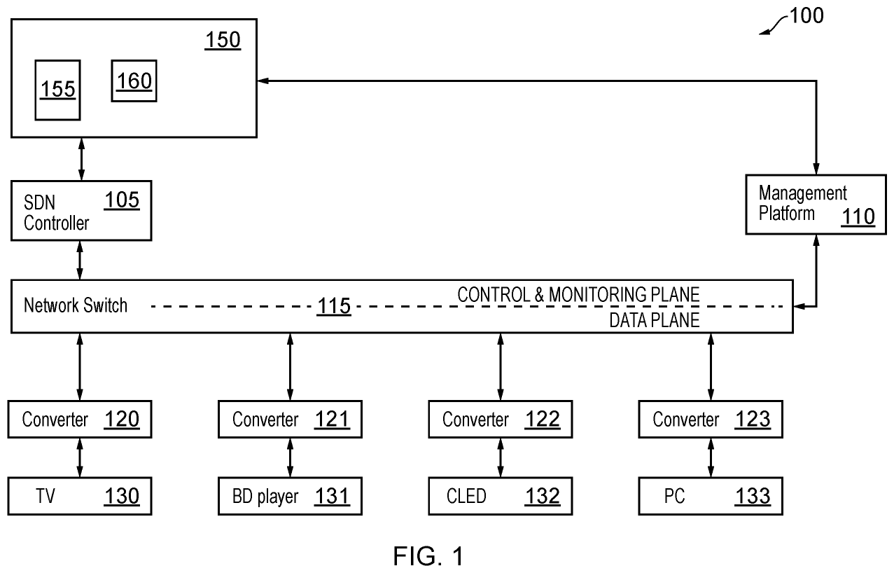

FIG. 1 describes a block diagram showing a network 100 to which embodiments of the disclosure are applied. The network 100 includes a network switch 115 which is configured to route IP packets around the network 100. The network switch 115 may be any kind of network switch which is capable of supporting the required bandwidth for AV over IP devices and which is capable of being connected to one or more AV over IP device. This may be a 10 Gbps, 25 Gbps or 100 Gbps switch. The network switch 115 may support monitoring features such as NETCONF. In addition, in instances, the network switch 115 may also support packet capture or statistic generation which might require an extended monitoring Application Programming Interface (API), or a Software Define Network (SDN) API such as OpenFlow. The network switch 115 may be considered to have a data plane and a control and monitoring plane as would be appreciated by the skilled person. These two planes have been identified in the Figure. Moreover, as would be appreciated, although only a single network switch 115 is shown in FIG. 1, the disclosure is not so limited and a network 100 according to embodiments may include a plurality of network switches.

Attached to ports within the network switch 115 are AV over IP devices 120-123. These AV over IP devices convert Audio and/or Video data and (where applicable) associated metadata to and from IP packets for distribution over the network 100 as appropriate. One example of such a device is a DisplayNet DN-200 Series device. It should be noted that the disclosure is not limited to AV over IP devices, and any device which sends or receives media content (such as AV data) over a computer network, or that converts media content (such as AV data) to and from IP packets for distribution over a computer network, is envisaged. These devices will be referred to “converter” hereinafter. As would be appreciated, although converters are described, the disclosure is not so limited. In instances, the source or destination for AV data may send or receive AV over IP natively. In other words, the disclosure is not limited to the instance of requiring a converter to convert the AV into IP data and vice versa; the AV device may distribute the AV over IP natively.

In the case that the AV over IP devices are converters, attached to each converter 120-123 is a source or destination for AV data. In other words, the source or destination is a media device that is a source of or destination for media content. In particular, a television 130 is connected to a first converter 120, a Blu-Ray® disc player 131 is connected to a second converter 121, a Crystal Light Emitting Diode (CLED) display 132 is connected to a third converter 122 and a computer 133 is connected to a fourth converter 123. The connection between the converter and the respective device may be a High Definition Multimedia Interface (HDMI) connector or Serial Digital Interface (SDI) connector or the like. Of course, the disclosure is not limited to any one type of connector and any kind of connector capable of carrying media content is envisaged.

Additionally connected to the network switch 115 is a management platform 110. The management platform 110 performs various tasks. For example, the management platform 110 may configure the converters 120-123 to define which multicast groups are being sent from which senders, and which multicast groups are being received by which receivers. The network device 115, in collaboration with the SDN Controller 105, makes sure the correct data is routed from the converters 120-123 by monitoring the control signals or packets (for example Internet Group Management Protocol (IGMP), Address Resolution Protocol (ARP) or the like). In other networks (such as legacy network), the SDN controller 105 is not present, and distributed software running on each network switch 115 may provide this functionality.

The management platform 110 may also configure the converters 120-123 so that an administrator can configure the routing of AV data between the converters. In other words, the management platform 110 may allow an administrator to allocate priorities to the various AV streams, types of data packets handled by the device and the like.

In the case of an SDN Network, additionally connected to the network switch 115 is a Software Defined Network (SDN) controller 105. The SDN controller 105 manages the flow of data traffic around the network according to forwarding policies put in place by the network administrator. Specifically, the SDN controller 105 reacts to sensed control packets between the converters 120-123 according to a policy set by the administrator. The SDN controller 105 is configured to instruct the network switch 115 to send IP packets between the devices based on these policies. In embodiments, the SDN controller 105 is a server (or more generally, computer architecture) onto which an SDN application is loaded. The SDN controller 105 sees a proportion of the data traffic sent through the network switch 115. Typically, the data traffic seen by the SDN controller 105 may be a subset of all data packets. In embodiments the subset may be a sampling of all packets, for example 1 in every 100 packets. In other embodiments, the SDN controller 105 provides this functionality by capturing the control packets and configuring the network devices' routing hardware (‘forwarding tables’, containing ‘flow entries’). Additionally, while capturing the control packets to implement these forwarding policies, the SDN controller 105 can also send the control information to the monitoring application 150 for analysis. This analysis will be explained later.

Although the above describes the SDN controller 105 as seeing all data traffic (or a subset thereof), the disclosure is not so limited. In embodiments, the SDN controller 105 is configured to see only selected traffic such as low bandwidth control traffic for example ARP, IGMP or LLDP traffic.

In embodiments, monitoring functionality could be implemented by replacing the SDN controller 105 with a module that uses other APIs provided by the network switch 115 (for example. NETCONF) to obtain similar information.

According to embodiments of the disclosure, a monitoring device 150 is also provided in the network 100. In embodiments, the monitoring device 150 is a sub-module located within the SDN controller 105. In other words, the monitoring device 150 is part of the SDN controller 150. However, in embodiments, the monitoring device 150 is a separate device which communicates with the SDN controller 105 via an Application Programming Interface (API). For ease of explanation, the monitoring device 150 includes control circuitry 160 and storage 155. The control circuitry 160 may take the form of a microprocessor formed of semiconductor circuitry which controls the operation of the monitoring device 150 under the control of software. The storage 155 may be embodied as semiconductor or magnetically readable storage and is configured to store the software which controls the control circuitry 150 and/or the state of the running software. In embodiments where the monitoring device 150 is a sub-module located within the SDN controller 105, the control circuitry 160 and the storage 155 may be embodied within the SDN controller 105.

Although not specifically shown, the monitoring device 150 may be connected to a display which may be viewed by a user. In addition or alternatively, the monitoring device 150 may generate reports which are used by other tools or by a user to make decisions.

The monitoring device 150 receives parameters relating to some or all the IP packets sent through the network switch 115. In particular, the monitoring device 150 receives parameters pertaining to the media content sent through the network switch 115 and control data sent by each of the devices. In the control data, there are two levels of control data; application level control data and network level control data. In the application level control data, the monitoring device 150 is provided information above the application level control data (such as video format) by the management platform 110. In the network level control data, (such as ARP, IGMP data), this is sensed by the SDN controller 105 (or some other monitoring API) and is passed to the monitoring device 150. The monitoring device 150 analyses the application level control data and the network level control data (which will be referred to as control data hereinafter). The monitoring device 150 uses the media content parameters and the control data to perform network traffic analysis and video configuration analysis and so the parameters received at the monitoring device 150 should enable this.

Examples of the parameters received by the monitoring device 150 includes network control data, such as the ARP packets that help map IP addresses to Ethernet hardware addresses, or multicast control data such as the IGMP packets. It could also include video control data such as Extended Display Identification Data (EDID) obtained from the management platform 110.

Moreover, further examples of the parameters received by the monitoring device 150 include metadata associated with broadcast media content, such as media content to be displayed on all the devices connected to the network, or metadata associated with either multicast media content which is media content sent from one device for display on a plurality of devices connected to the network or unicast media content which is media content sent from one device for display on another device connected to the network. In embodiments, the media content is multicast media content but the disclosure is not so limited.

The parameters received by the monitoring device 150 further include information relating to each device connected to the network. This includes configuration data for each device such as technical capabilities of each device (for example the resolution of images supported by the device or the frame rate of each device), any user defined parameters such as whether device has a specific priority within a network or whether the device is a protected device such that the media content provided to the protected device is prioritised over the media content provided to non-protected devices. The configuration data, user defined parameters or whether the media content provided to a protected device are all examples of properties of the device or network. Control data for each device such as the MAC address of each device, the IP address allocated to each device is also provided to the monitoring device 150.

The monitoring device 150 may receive the information from the SDN controller 105 or from the management platform 110.

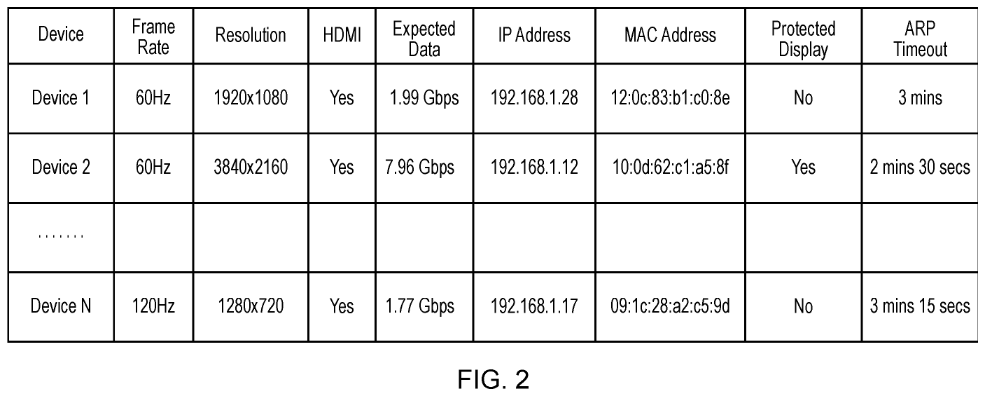

FIG. 2 shows a data structure associated with each device on the network stored within the storage 155 of the monitoring device 150. In embodiments, the data structure is a database or table structure. Although the data structure of FIG. 2 shows a number of parameters, the disclosure is not so limited and the data structure may include any parameters such as pixel depth/bits per pixel (8, 10, 12, 16, or the like.) and chroma subsampling format (4:2:0, 4:2:2:, 4:4:4:, or the like).

In addition to the data structure associated with each device, the storage 155 will include parameters associated with the network to which each device is connected. These network parameters may include network capacity (i.e. how much data the network can handle at any one time before network collapse occurs), acceptable latency with the network and the like. These network parameters may be stored within the data structure of FIG. 2 or elsewhere within the storage 155.

In FIG. 2, the data structure includes at least some of the technical capabilities of each device. For example, the frame rate supported by the device, the resolution supported by the device, and the connectivity supported by each device are stored in the data structure. In the example of FIG. 2, device 1 has a frame rate of 60 Hz, a resolution of 1920×1080 and supports HDMI. However, other technical capabilities of each device may be stored including the colour depth factor or the coefficient (bits/clock), supported compression or encoding or the like.

Also, whilst only a single value is shown in FIG. 2, the disclosure is not so limited. In embodiments, a plurality of values may be stored against each entry in the data structure. For example, device 1, may also support 1280×720, 3840×2160 (4K) or 7680×4320 (8K) or the like. In this instance, all supported (or subset thereof) resolutions may be included in the entry. However, in the event that there is a plurality of supported resolutions or frame rates, the currently utilised frame rate and resolution are noted within the data structure. Additionally, in the event that there is a plurality of supported resolutions or frame rates, the optimal and/or preferred frame rate and resolution are noted within the data structure.

In addition, the expected data rate of media content provided to or provided by each device is stored. In other words, the monitoring device 150 is configured to calculate the amount of expected data of media content that is to be received or transmitted from each device. This value is based on the frame rate, and the resolution supported by the device and currently in use on the device. So, for example, in the event that device 1 has a frame rate of 60 Hz and a resolution of 1920×1080, the expected video data bandwidth per channel is 1.99 Gbps. As would be appreciated, the amount of data of media content may be pre-defined or loaded from a configuration file or the like. Of course, if the supported compression or encoding were to be applied to the media content, the expected data rate may be altered. The purpose of defining the expected data rate is to identify if a device is providing or is being provided with media content in an unsupported or undesirable format. This will negatively impact on the operation of the device. In this case, and as will be explained later, the monitoring device 150 will identify such a situation.

In addition, the control data for each device is stored within the data structure of FIG. 2. In this case, the IP address and MAC address of each device is stored within the data structure. Other control data such as the ARP cache timeout associated with each device connected to the network is stored in the data structure.

Finally, user defined data such as whether a device is a protected device is stored within the data structure.

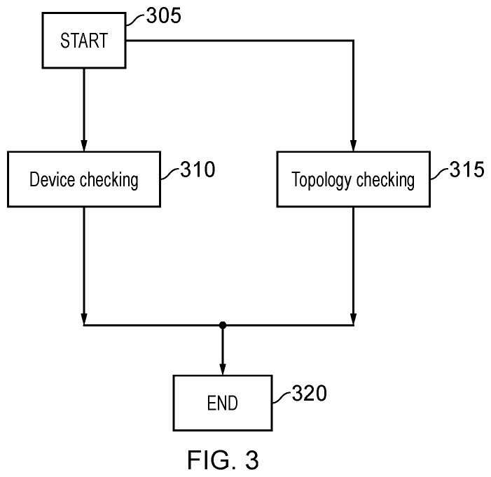

The operation of the monitoring device 150 according to embodiments will now be explained with reference to FIGS. 3 to 10.

FIG. 3 shows a flow chart 300 explaining an initial network function monitoring carried out by the monitoring device 150. The flow chart starts at step 305. The process then moves to step 310 where the devices on the network are checked.

During the check in step 310, the assigned IP address of each device stored within the monitoring device 150 is checked against either a manually entered IP address defined when the network was constructed or a static/expected topology file. In order to generate a static topology file, a network design tool may be stored within the monitoring device 150, an external tool may be used, or it may be generated by any other suitable means. A warning may be issued in the event of a mismatch. In order to achieve this, the Link Layer Discovery Protocol (LLDP) traffic will be analysed, or in cases where LLDP is not supported a ping will be sent to each expected device to check the physical topology of the network 100.

In addition, during the check in step 310, any unknown unicast or multicast destination addresses detected, but not within the information provided by the network administrator, may be identified. As will be appreciated, in embodiments, this can occur at any time as the detection will occur when the data is sent for the first time. Further any unknown source IP addresses for any kind of data traffic may be identified. This warns of any rogue addresses or unexpected devices located on the network. Moreover, as an additional security step to prevent inadvertent use of the network, the monitoring device 150 may ask the user to confirm before allowing the SDN controller 105 to add a route to an unrecognised device.

At the same time as checking the devices in step 310, the topology of the network is checked in step 315.

In step 315, a check for mismatched subnets and multicast ranges may be made. In this case, a network administrator may provide information like a unicast subnet and allowed multicast ranges and the actual configuration of the network is checked against this information. Again, a mismatch may be identified and a warning issued.

In order to avoid the need to operate a separate DCHP server for a media content system, a DHCP server may be provided by the monitoring device 150 at step 315. Further, a check will be carried out to identify any problems with corporate proxies. This is particularly useful if the network 100 is bridged to a network outside the corporate firewall.

A check may also carried out to determine if any media content packets escape the network or are being injected into the network. Other checks that may be carried out include a check for corporate proxies. Finally, multiple subnet detection is carried out in step 315.

A further check may be provided to determine if the network 100 is a non-blocking network. In this case, any non-blocking guarantees defined within the network may be stored within the monitoring device 150 to determine whether the amount of non-media content unicast traffic on the network will break the non-blocking guarantee.

The process then ends in step 320.

In embodiments, the device checking of step 310 is carried in ARP and IGMP handling and the topology checking of step 315 is carried out when there is a change of topology. Of course, the disclosure is not so limited.

After the network topology has been checked, and the network is operational, the monitoring device 150 begins monitoring the media content and the control data flowing around the network 100.

As noted above, the monitoring device 150 monitors the routing/network control data.

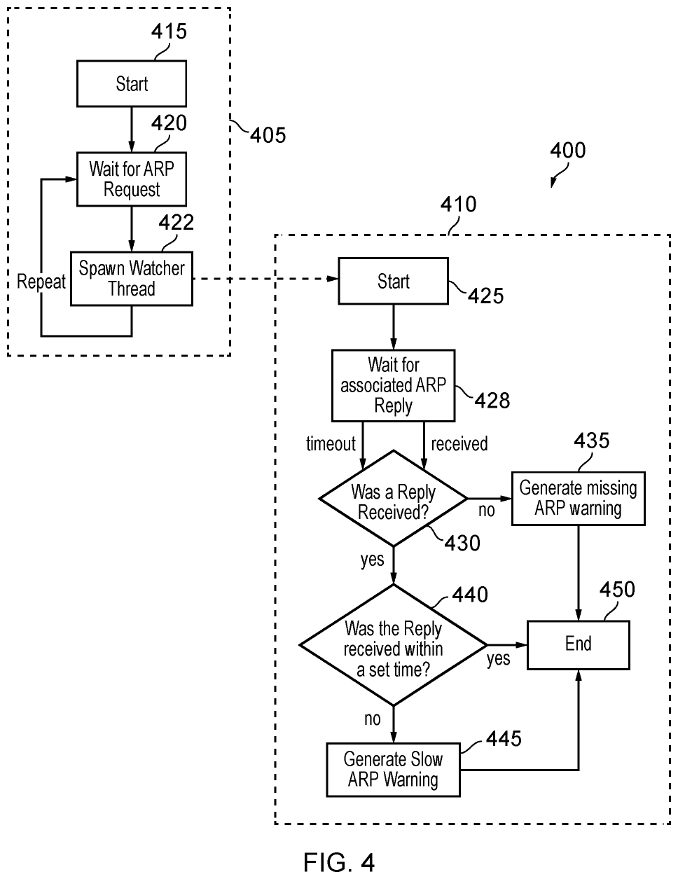

FIG. 4 shows a flow chart 400 explaining the detection and analysis of ARP packets in the monitoring device 150 according to embodiments. As would be appreciated, ARP packets are one example of routing and/or network control packets.

The process 400 is comprised of a main process thread 405 and a plurality of short-lived watcher process threads 410. The main process thread 405 starts at step 415. The main process thread 405 then moves to step 420 where the thread waits for an ARP Request from any device to be detected by the monitoring device 150 (via the SDN Controller 105). When an ARP Request packet is detected, the main process thread 405 moves to step 422 and spawns a short-lived watcher thread 410. The main process then follows the “repeat” path and waits for further ARP request packets.

For each watcher thread instance 410, created in response to an Associated ARP Request packet detected in step 420 of the main process thread, the watcher process thread starts concurrently at step 425.

The watcher process then moves to step 428 and waits for an ARP Reply to the associated ARP Request. When an associated ARP Reply is received, the process moves to step 430 via the “received” path. Alternatively, if the wait step times out after a period sufficient to infer that no ARP Reply is forthcoming, the period of which may be set by an administrator, the process moves to step 430 via the “timeout” path.

In step 430 a check is made to determine whether an ARP Reply was received. In the event an ARP Reply was not received, the “no” path is followed to step 435 where an alert (or other warning) is generated. The alert indicates that ARP packets are not being transmitted and may be an audible alarm or visual alert. The alert may be any kind of event, such as an audible alarm or recommendation provided to the user to address the problem. The watcher processing event 410 then ends in step 450.

Returning to step 430, in the event that the ARP Reply was received before step 428 timed out, the “yes” path is followed to step 440. In step 440, a check is made to determine is the ARP response was received within a pre-determined time period. The pre-determined time period may be set by the administrator of the network and may be a period of time which is less than the time out period of step 428, but is slow for the network. If the ARP response was received within the pre-determined time period, the “yes” path is followed to step 450 where the process ends.

Alternatively, in the event that the ARP response was not received within the pre-determined time period, the “no” path is followed to step 445 where an alert (or other warning) is issued indicating that the ARP response was slow. Again, this warning may be an audible or visual warning for the user and may also include a recommendation to solve the problem or perform any other kind of event. The process then moves to step 450 where the watcher process thread 410 ends.

By providing a warning to the user, it is possible for the user to analyse the network configuration and identify the problem with the network. According to embodiments, the warning identifies the precise problem with the network. This assists the user in correcting the problem. Moreover, as noted in further embodiments, in addition to the warning, the monitoring device 150 may also provide a solution or recommendation to the problem from a database of possible solutions to be tried by the user. For example, in addition to issuing the warning that an ARP Response timeout has occurred, the user may be directed to various solutions or recommendations to solve such a problem. The recommendation may be a new configuration for one of the first device, second device or the network. In other instances, it is possible that the user is provided a questionnaire that allows the user to answer further questions which better identifies the precise problem and direct the user to a more efficient solution.

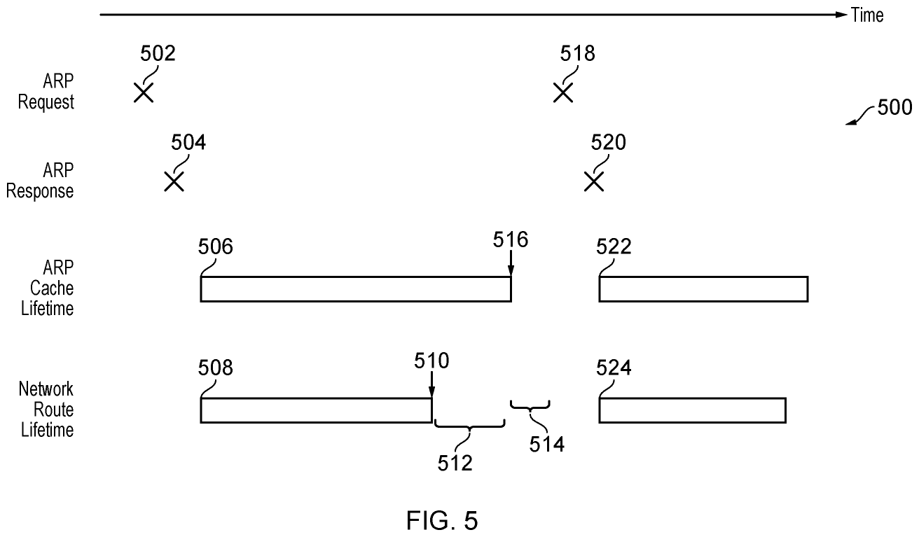

FIG. 5 shows a problem with ARP cache timeouts that is identified by embodiments of the disclosure. This is shown as a timeline 500. In step 502 an ARP Request is issued by a device. A corresponding ARP Response 504 then received by the device. The ARP cache clock is started at step 506 as the device issuing the ARP request writes the response to its ARP cache. At the same time, the network route clock is started at step 508. However, the network route timeout expires at step 510 and the ARP cache timeout expires at step 516. As will be seen, the ARP cache timeout expires after the network route timeout. This means that data packets sent in period 512 will not be delivered. This is because the ARP cache has yet to timeout but the network route has timed out. Therefore, data packets will be sent by a device but will not be received at the desired device.

After the ARP cache has timed out in period 514, the data packets sent in this period will generate an ARP request at step 518 and the corresponding ARP Response at step 520. This resets the ARP cache clock and the network route clock at steps 522 and 524.

This difference in the ARP cache timeout and the network route timeout means that data packets sent in period 512 will not be delivered.

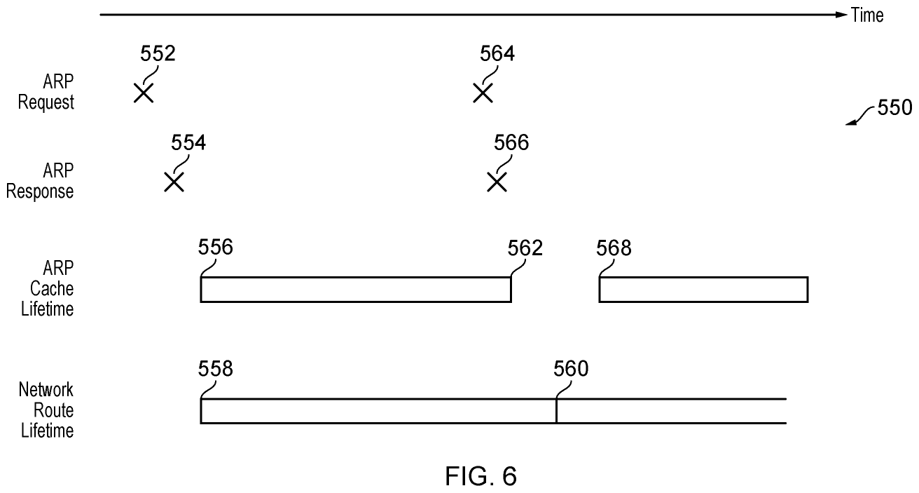

FIG. 6 shows a timing diagram where the problems associated with FIG. 5 are not present. In the timing diagram 550 of FIG. 6, the ARP Request 552 is sent from the device and a corresponding ARP Response is received in step 554. At this point, the ARP cache timer and the network route timer are reset in steps 556 and 558 respectively. Unlike the embodiment of FIG. 5, however, in FIG. 6, the ARP cache expires before the network route. Specifically, the ARP cache expires at step 562. This means that the ARP Request is issued at step 564 and the corresponding response received at step 566 resets the network route timer before the network route expires. Therefore, all packets are delivered as the network route timer has not expired before the expiration of the ARP timer. In the embodiments of FIG. 6, the ARP cache timer is reset at step 568 and the network route would have expired at 560. In this case, however, as the ARP cache has not expired, the network route clock is reset at step 560.

In the above, the ARP request, the ARP response, the ARP cache timeout and the network route timeout are all examples of events. These events may relate to co-dependent parameters. The analysis described here allows the monitoring device 150 to detect when such co-dependent parameters are not configured appropriately, as shown in FIG. 5, allowing the administrator to change the co-dependent parameters to be configured appropriately, as shown in FIG. 6. In this example the co-dependent parameters are the ARP cache timeout and the network route timeout, but it is understood that the disclosure is applicable to a group of any two or more such co-dependent parameters.

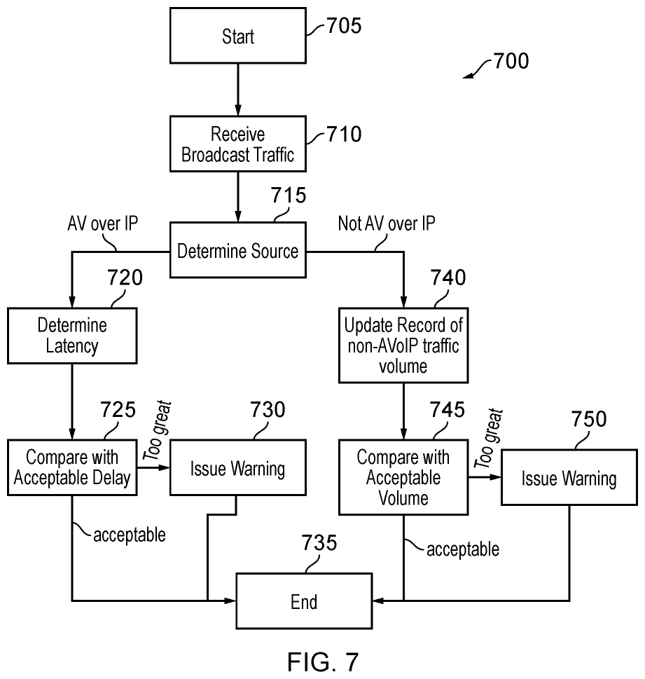

FIG. 7 shows a flow chart explaining the monitoring of broadcast traffic by monitoring device 150. Many AV over IP devices broadcast control data and so it is desirable to monitor or prevent the non-AV over IP devices from sending excessive broadcast data over the network as this may impede or delay the control data broadcast by the AV over IP devices from reaching their destinations. The process 700 begins at step 705. The process moves to step 710 where broadcast traffic (such as ARP traffic or other control data) is received by the monitoring device 150. The source of the received broadcast traffic is established. This is achieved by analysis of the received broadcast IP packets and takes place in step 715.

In the event that the source of the broadcast traffic is not one of converter 1 120, converter 2 121, converter 3 122 or converter 4 123, then the process moves to step 735 and ends. In other words, if the source of the broadcast data is not an AV over IP device, the process moves to step 740. In step 740, the amount or volume of the non-AV over IP traffic is determined. This volume is recorded along with a timestamp in step 740. The process moves to step 745 where a comparison is performed to determine whether the recorded volume is compared with an acceptable amount or volume. In the event that the recorded volume is in excess of the acceptable volume, a warning is issued in step 750. This warning may be an audible or visual warning. Alternatively, in the event that the recorded volume is within acceptable limits, the process moves to step 735 and ends.

In the event that the broadcast traffic is AV over IP broadcast traffic, the latency of the broadcast traffic is determined in step 720. The latency of the broadcast IP packets may be determined by analysing the difference in the time the packet that was issued by the source device and the time it was received by the monitoring apparatus 150. This indicates the latency of the SDN controller 105. In embodiments, it is possible to timestamp broadcast packets which allows the processing latency of the SDN controller 105 to be accurately measured.

In other embodiments, a timestamp of a packet received in the SDN controller 105 and the time the packet was sent by the switch 115 may be able to determine the volume of traffic being sent via the SDN controller 105 and compare this to the available bandwidth of network link between the switch 115 and the SDN controller 105 to estimate if broadcast traffic is impeded by a bottleneck. Latency may also be determined in this manner especially if these timestamps are supported by hardware.

In other embodiments, latency may be determined by measuring the timestamp at the time the broadcast packet is received at the switch 115 and the time the copies are sent from the switch 115.

The process moves to step 725 where the latency is compared with an acceptable latency defined when the network was configured or taken from a snapshot of when the network was operating in a good manner. Typically, whether a latency period is acceptable will depend upon the types of devices connected to the network and the types of broadcast traffic sent over the network. Where the network is connected to many devices where the control data for these devices is broadcast over the network, then a low latency is required. It is desirable, therefore, to reduce the amount of non-control broadcast data sent over the network.

If the latency is too great, then the “too great” path is followed to step 730 where a warning is provided to the user identifying the latency, the type of broadcast data and the source of such broadcast data. The warning may be visual or audible. The process ends at step 735.

Alternatively, if the latency is acceptable, the “acceptable delay” path is followed to step 735 where the process ends.

In other embodiments, the broadcast latency may be measured as described above in step 720 and then the latency measurement may be provided to the user or administrator after which the process will end,

Although the embodiments of FIG. 7 describe identifying latency in broadcast traffic, the disclosure is not so limited. For example, in embodiments, a similar process may be followed for unicast traffic, control packets, or any other class of packets which are of interest. This is because in a network having a large proportion of media content flow around, a typical assumption is that broadcast traffic, unicast traffic or any other control traffic should be small compared to AV traffic and network capacity.

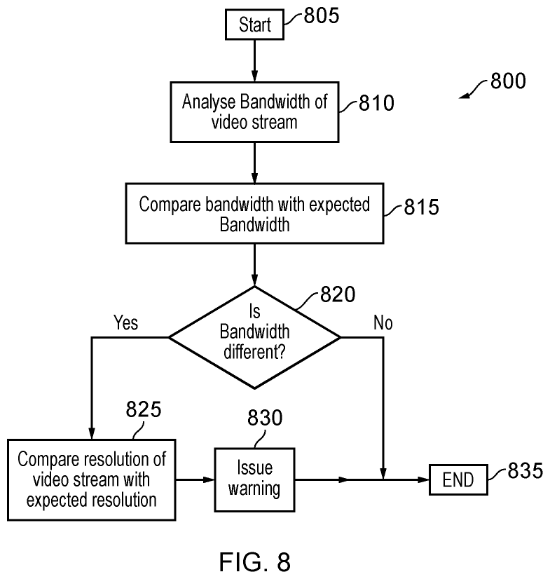

In FIG. 8 a flow chart explaining a mechanism for identifying if a converter or its connected AV device is not operating correctly. The process 800 starts at step 805. The process then moves to step 810 where the bandwidth of the media content traffic from one converter is analysed. In embodiments, the bandwidth is one example of a parameter of the media content. In the embodiment of FIG. 8, the media content traffic is a video stream. However, the disclosure is not so limited and the media content traffic may include audio or audio and video traffic.

The bandwidth of the media content is compared with the expected data from the data structure of FIG. 2. This is step 815. The expected data is one example of a parameter associated with a device. This is because the expected data is contingent on the frame rate of the device and the content expected at the device and the resolution of the device and of the content expected at the device.

The process moves to step 820 where it is determined if the bandwidth is different. In the event that the bandwidth is not different (or only different by less than a predetermined amount), the “no” path is followed to step 835 where the process ends.

Alternatively, if the bandwidth is different (or different by more than a predetermined amount), then the “yes” path is followed to step 825. In this case, the resolution of the media content (such as the video content in the video stream) is compared with the video resolution expected from the device. This expected information is obtained from the data structure of FIG. 2. The video resolution of the video stream may be determined from the average bandwidth of the video stream over a period of time. A warning may be issued to the user identifying that the bandwidth is not as expected and either the video resolution of the video stream is as expected or is different to that expected. A warning is one example of an event when there is a negative comparison between the parameter of the content and the parameter of the device. The warning may be visual or audible.

This is useful because provision of this information will assist the user in identifying the probable cause of any issues with device. For example, where the bandwidth is not as expected and the video resolution of the media content is different to that expected means that the resolution of the device has changed or the converter is not operating correctly. However, where the bandwidth is different and the resolution of the video is as expected indicates a different problem with either the device or converter. The process then ends at step 835.

In embodiments, this may also identify the situation where the resolution of a video stream has been downgraded with no warning issued. For example, a 4K source being sent to a 4K display may be downgraded to High Definition for no apparent reason, This mechanism identifies this particular situation and warns the administrator accordingly.

In embodiments, the monitoring device 150 may perform flow statistics and port statistics so that the most active traffic flows and most active ports are identified. These can be compared to expected flow and port statistics and where there is a traffic flow or port that is more active than expected, a flag may be issued.

In embodiments, the monitoring device 150 will determine the entire bandwidth used by the network. This will be compared with the maximum bandwidth for the network which is determined during the initial configuration of the network and which is stored in the storage 155. In the event that the bandwidth used by the network is within a predetermined amount of the maximum, a warning is issued to the user. The maximum bandwidth may be the theoretical maximum bandwidth or may be the maximum bandwidth acceptable to avoid a network collapse.

In embodiments, one or more converter may dynamically alter the bitrate of the media content stream to match the available bandwidth. Specifically, in embodiments, a change in bandwidth would be noticed with no corresponding change in video parameters such as video resolution of frame rate or the like. In this case, the monitoring device 150 may flag this change of bitrate as an event and/or issue a warning or alarm.

In embodiments, Internet Group Management Protocol (IGMP) traffic is analysed by the monitoring device 150. The process explained with references to FIGS. 4A to 6 may be used to reduce the effect of different IGMP timeouts on different devices. In other words, the processes explained with reference to ARP Traffic may equally be applied to IGMP traffic.

In embodiments, the monitoring device 150 may include a display which shows all the devices and which shows the video resolutions and formats used on each device. The display may just list the video resolutions and formats used on the network. In further embodiments, the status of the video connection between the converter and the device may be shown on the display. The display may also identify any video connection that are not functioning or have not negotiated a format (in the case of a video connection that supports format negotiation such as HDMI). In embodiments, the chart of FIG. 6 may be adapted to show events such as the change in negotiated format of the video connection. Further, any problems with content protection on the video connection may be displayed. For example, any errors caused by the High Bandwidth Digital Content Protection on the HDMI connection should be displayed. This allows the user to easily see and rectify the problem with the device or converter.

In embodiments, the monitoring device 150 will show on the display any failures within the network of compliance with networking standards. For example, in the event that a device continually performs ARP timeout, this will be shown on the display.

In embodiments, the monitoring device 150 may probe the converter to a socket level. The results of this probe may also be shown on the display.

In embodiments, the monitoring device 150 will identify any device that has Electronic Device ID (EDID) enabled. This is useful because in networks that provide Media Content by multicasting, one converter may negotiate a particular video format or resolution with one device which is then applied to all devices to which the converter multicasts the content. The video format and/or resolution may not be appropriate for all devices which are being multicast to. Alternatively, if the other devices are capable of receiving the video content in the format and/or resolution, then the other devices each need to re-negotiate with the source device. This increases the time before the media content may be sent over the network and may also cause re-negotiation of other devices receiving the stream caused by the first re-negotiation. By identifying devices that have EDID enabled, and if the media content is delayed in being sent over the network, the user can quickly see if this problem is causing the delay.

In a multicast media content system, where the same media content is provided to multiple devices, all supporting different frame rates and video resolutions, the media content provided to one device in one frame rate and video resolution may be suitable, but when sent to a different device with that frame rate or at that video resolution is not appropriate. In the example of FIG. 1, media content sent to display 130 at a resolution of 1920×1080 may not be appropriate for the crystal liquid emitting diode that has a much higher resolution of 3840×2160. The common video format will be negotiated between the converters and the management platform 110. This negotiation may not take into account the different supported video resolution and frame rates. Therefore, according to embodiments of the disclosure, the selections made during this negotiation are checked by the monitoring device 150 and one or more warnings or suggestions will be provided to the user to assist in addressing any sub-optimal configurations.

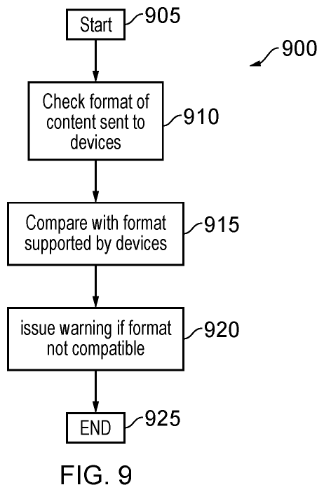

FIG. 9 therefore shows a flow chart 900 explaining the analysis of video format conversions according to embodiments to mitigate against this situation.

The process 900 starts at step 905. The process then moves to step 910 where the frame rate and/or resolution of the video and/or bit depth and/or chroma format and/or audio of the media content sent to each device is checked. The frame rate and/or resolution and/or bit depth and/or chroma format of the media content of the source device are also checked. The frame rate and/or resolution and/or bit depth and/or chroma format of the media content are examples of a parameter of the media content. The process moves to step 915 where the frame rate and/or resolution of the media content is compared with that supported by the device. In other words, the parameter of the media content is compared with a parameter of the device. The frame rate and/or resolution is stored in the data structure 200. The process then moves to step 920 where a warning is issued in the event that the frame rate and/or resolution and/or bit depth and/or chroma format is not supported. In other words, the warning is an example of an event that is performed in the event of a negative comparison. This warning may be a visual warning on the display of the monitoring device 150 or may be an audible warning. The process then ends in step 925. It should be noted here, that although the comparison is made between a parameter of the media content and a corresponding parameter of the device, the disclosure is not so limited and the comparison could be made between the media content and any one or more of the device, a second device on the network or the network.

As the monitoring device 150 has the data structure 200 identifying the technical characteristics of each device located on the network, the monitoring device 150 may establish the most common native resolution or native frame rate supported by each device to which the media content is being multicast. The monitoring device 150 may indicate in the warning the most common native resolution or native frame rate on the network so that the user may change the resolution (or frame rate) to that most common native resolution or frame rate. This reduces the number of conversions required for the multicast media content and therefore improves the quality of the media content output from each device.

In embodiments, the user or designer of the network may specify devices as being protected devices. As noted in FIG. 2, this information is stored within the data structure 200. The protected device is a device which is provided with media content at their native resolution and/or frame rate. In this instance, with the embodiment of FIG. 9, the monitoring device 150 may issue a warning identifying that any one of these protected devices is being provided with media content not at the native resolution and/or frame rate. In embodiments, the user or designer of the network 100 may provide each device with a priority value which would weight the analysis of the most common native resolution and/or frame rate. So, for example, if a device is a protected device, then the media content must be provided to the device in its native resolution and/or video format. However, if the device has a higher priority than another device, then the likelihood of the device having the higher priority receiving the media content in its native resolution and/or frame rate is increased but not guaranteed. This aims to mitigate the situation where a large display such as a crystal LED display receives media content at the same resolution as a mobile telephone on the network.

In one arrangement, for example, a conference hall may have a large crystal LED display located in the hall, with smaller displays located at the side of the room and smaller displays outside the conference hall. In this situation, the crystal LED display may have a high priority and the other side displays may have a lower priority than the crystal LED display and the displays located outside of the conference hall may have an even lower priority. This means that the user or designer of the network has flexibility to ensure that the media content is provided to each device in the most appropriate format for the device and the use of that device. In embodiments, the protected device and priority of each device may be applied to streams of media content being sent across the network and the user is warned that the 4K display is not receiving optimal resolution content because of the mobile phone.

In the event that a compromise is required as all the displays must receive the same multicast media content, so that one or more of the displays must perform a conversion of video parameter, then the priority is used to choose which display receives the native stream.

The priority may also be combined with other characteristics such as available bandwidth (for example, when multicasting to a 4K display (highest priority) and HD display (medium priority) and a mobile phone (low priority), but the mobile phone can never receive 4K due to bandwidth constraints then HD is chosen because it is the closest resolution to 4K that the mobile telephone can accept. Alternatively, the monitoring device 150 could instruct the SDN Controller 105 to block the connection of the mobile phone because it would have a detrimental effect on the higher priority 4K display.

In some networks where media content is provided, it is possible to route the audio and video component of the media content to different devices. For example, in a home network the video component may be routed to a display and the audio component may be routed to separate speakers. However, in larger networks, where many devices exist on the network, the audio component may be routed to speakers in a completely different physical location to the display or multiple audio streams might be routed for mixing. In order to mitigate the impact of this type of situation, in embodiments, the user is informed or warned when the audio and/or video and/or metadata streams associated with media content are being routed to different places. The database of FIG. 2 may store information indicating whether the audio and/or video and/or metadata streams associated with media content should be routed to different places.

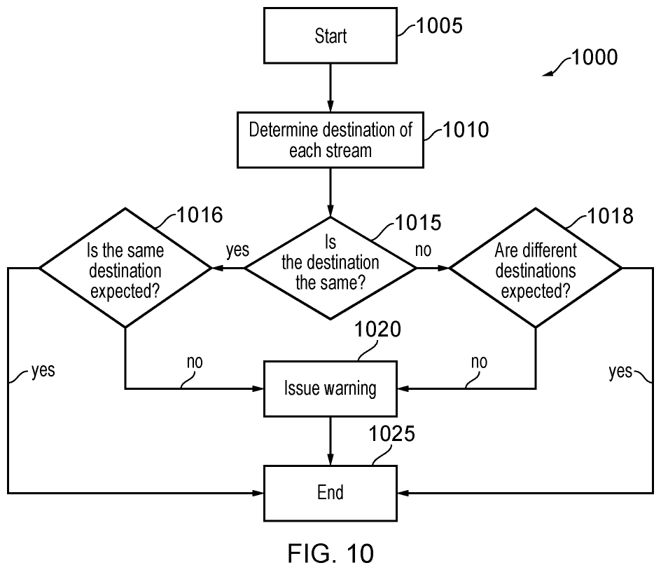

FIG. 10 shows a flow chart describing embodiments of the disclosure to mitigate this problem.

The process 1000 starts at step 1005. The process then moves to step 1010 where the destination of one or more of the audio, video and/or metadata stream in the media content is determined by the monitoring device 150. The process then moves to step 1015 where a check is made to determine if the destination is the same. In the event that the destination is the same, the “yes” path is followed to step 1016. In this instance a check is made to determine whether the same destination was expected. In the event that the same destination was expected, the “yes” path is followed and the process ends at step 1025. However, if the same destination was not expected, the “no” path is followed to step 1020 where a warning is issued to the user. In a similar manner to the previous embodiments, the warning may be an audible and/or visual warning. The process then ends in step 1025.

Returning to step 1015, if the destination is not the same, the “no” path is followed to step 1018 where a check is made to determine if different destinations are expected. If different destinations are not expected, the “no” path is followed to step 1020 where a warning is issued. However, if different destinations are expected, the “yes” path is followed to step 1025 where the process ends.

In embodiments of FIG. 10, the parameter is the destination of a video component, audio component and metadata component of the media content all being the second device.

As noted above, it is possible that the monitoring device 150 may provide suggestions to the user to address technical issues with devices on the network or with the network itself. In the example of FIG. 9, the suggestions included defining an appropriate resolution and/or frame rate for the media content. It is noted that the disclosure is not so limited. In other embodiments, the monitoring device 150 may enter an advisor mode. In this case, when a warning is issued to the user, the monitoring device 150 may check with a database (either stored locally in storage 155 or stored remotely on the network 100 or on the Internet). The database will include many solutions to various problems identified by the monitoring device 150. These solutions may include diagrammatical information which the user may follow or a video of a person performing certain remedial (for example, predetermined) actions or may provide a written explanation of the solution. One such predetermined action is to apply a new configuration to one of the first device, second device or network.

In the above embodiments, the media content is analysed on the network. In embodiments, where the analysis relates to graphing time series data like port traffic statistics, adaptive data smoothing is applied to the time series data. In this case, the time series data is collected at a high sample rate and placed into a time series database. The data is then processed using advanced or adaptive filters to smooth the graphs. One such filter may be a selective low-pass filter with a sharp cut-off. This would pass changes to the average data rate over the time series but would smooth the higher frequency rate fluctuations. This output is displayed to the user of the monitoring device 150. This reduces the amount of noise displayed to the user from rapidly changing and volatile data changes.

In embodiments, snapshots of the network configuration may be captured when the network is operating correctly. These snapshots could include system configuration snapshots.

In addition, or alternatively, these snapshots may include measured parameters such as measured traffic loading, measured latencies, measured timeouts. These parameters would be captured when the system is known to be operating correctly then used as threshold parameters during subsequent operation to warn of potential problems.

In some embodiments, a current configuration can be compared to a previous known good snapshot in order to identify anything that is different and where there are differences the system can be arranged to generate one or more suggested configuration adjustments to improve the current configuration.

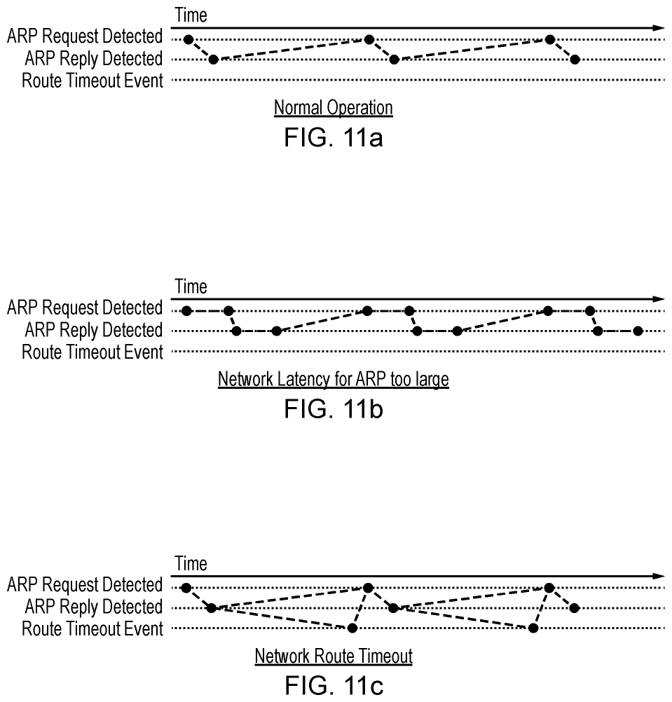

FIGS. 11a, 11b and 11c show charts which assist a user in visualising the operation of a network. These charts all include events generated by embodiments of the disclosure plotted on a timeline.

FIG. 11a shows an embodiment with normal operation of the network. As will be apparent, the event of the ARP Request being detected and an ARP Response being detected are plotted. In this case, a pattern of ARP Request and a short time later, an ARP Reply is expected. The time period between the ARP Request and corresponding ARP Reply is expected to be small compared with the time period between an ARP Reply and the subsequent ARP Request.

FIG. 11b shows an embodiment of the chart where the network latency for ARP is too large. In this instance two ARP Requests are detected before any ARP Response is received. Of course any number of ARP Requests may be detected would be appreciated. In the event that multiple ARP Requests are detected, multiple ARP responses are received. This indicates that the network latency for ARP is too large, causing the ARP Request to be retried multiple times. The user will then be able to correct for this or will be provided with instructions explaining the process to correct for this.

FIG. 11c shows an embodiment of the chart where the network route timeout occurs. In this instance, an ARP Request is detected and a short time later a corresponding ARP Response is detected. However, in this instance, a network route timeout event is detected before the next ARP Request is detected. It is important to note that in the example of FIG. 11c, two instances of this pattern are shown. This is because, under light traffic, an occasional network route timeout may be expected. However, a pattern of network route timeouts, with for example, a constant time period between the timeouts may indicate a problem similar to that of FIG. 6.

Although the above describes the charts being displayed to the user, Artificial Intelligence may be used to spot these patterns and identify a problem and corresponding solution instead.

Although the above shows a timeline having a single event at each moment of time, the disclosure is not so limited. In embodiments, two or more events may occur at the same time (i.e. ARP packets to two or more IP addresses or the like). In addition, events that relate to one another (for example ARP Packets relating to the same network address) may be joined by lines to show the relationships. In addition, colour coding may be used to assist in the visualisation so that detected errors from the patterns may be used to identify errors. Further, the user may apply a filter to show a simplified timeline including only certain events.

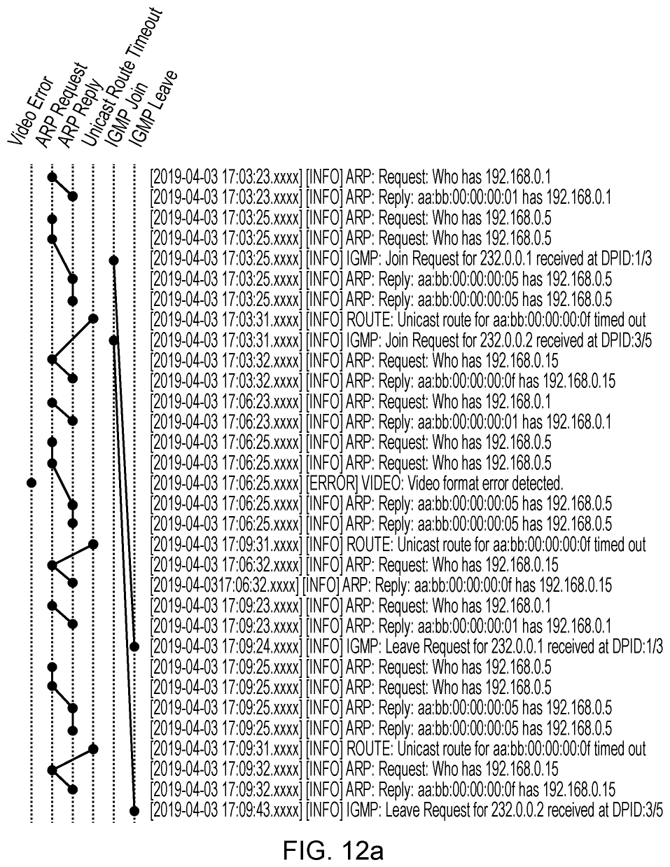

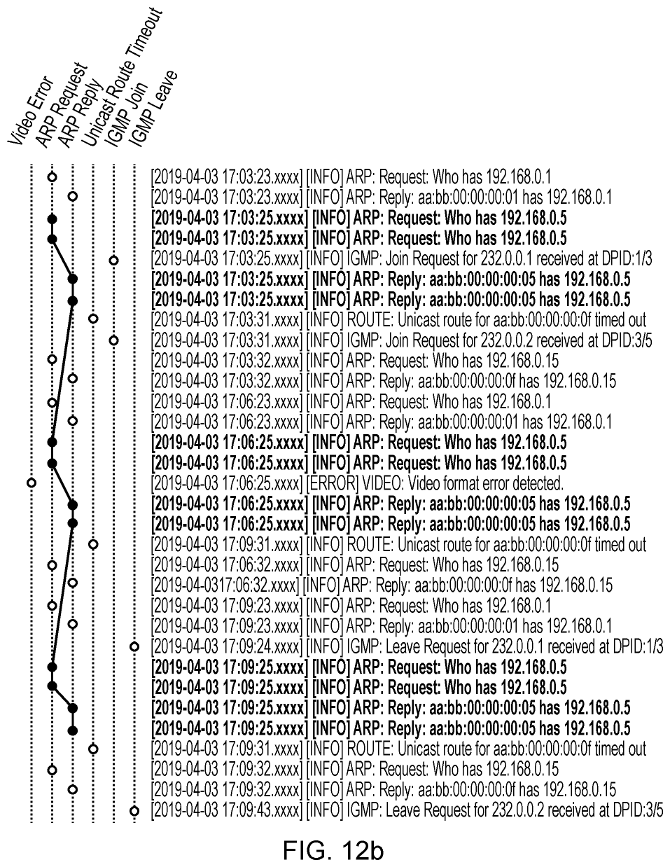

FIGS. 12a and 12b show alternative visualisation techniques which may assist the user. In FIGS. 12a and 12b, time is not an axis, but rather, the sequence of events is shown. In the example of FIG. 12a, all the events are shown with lines connecting related events. A summary of the event is provided next to the chart in line with the event so that a user can easily identify the event with the summary. In the event of an error (in this case, a video format error), no line is provided and the colour of the event (and the summary) may be different. FIG. 12b shows a further embodiment to that of FIG. 12a. In the embodiment of FIG. 12b, all events related to the event currently under the mouse cursor are highlighted by displaying the event labels in bold, the event markers in a colour indicating the error or non-error status, and lines between the event markers to indicate their connection. Typically, these colours will be different. In the situation where events are not related, no lines are used to connect these events. Events not related to the event under the mouse cursor are not thus highlighted. It will be appreciated that as the user moves the mouse cursor over the area of the event viewer, different groups of events will be highlighted. This allows a user to identify complex errors caused by the interactions of multiple system events more easily.

Numerous modifications and variations of the present disclosure are possible in light of the above teachings. It is therefore to be understood that within the scope of the appended claims, the disclosure may be practiced otherwise than as specifically described herein.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

Embodiments of the present technique can generally described by the following numbered clauses:

1. A method of monitoring a network having a first and second device, comprising:
receiving IP packets containing media content from the first device on the network, the IP packets being sent to the second device;
analysing the received IP packets to determine a parameter of the media content;
analysing the parameter of the media content and a parameter associated with the second device, wherein in the event that the parameter of the media content is different to the parameter associated with the second device, the method comprises:
comparing these parameters to a property of the configuration of at least one of the network, first device or second device; and
performing a predetermined action.

2. A method according to clause 1, wherein the parameter of the media content is the frame rate and/or resolution and/or bit depth and/or chroma format of the media content.

3. A method according to clause 1, wherein the parameter of the media content is the bandwidth of the media content.

4. A method according to clause 1, wherein the parameter is the destination of a video component, audio component and metadata component of the media content all being the second device.

5. A method according to any preceding clause, wherein the predetermined action is to provide a message to a user.

6. A method according to clause 5, wherein the message is a warning or a recommendation.

7. A method according to clause 5 or 6, wherein the recommendation is a new configuration of at least one of the network, first device or second device.

8. A method according to any one of clauses 1 to 4, wherein the predetermined action is to apply a new configuration to at least one of the network, first device or second device automatically.

9. A method of monitoring a network having a first device and a second device, comprising:
receiving IP packets containing control data being transmitted on the network;
analysing the received IP packets to determine the source of the IP packets; and
in the event that the source of the IP packets is not a media device, the method comprises:
determining the latency of the IP packets; and in the event that the latency is above a threshold latency, the method comprises:
providing a warning to the user.

10. A method according to clause 9, wherein the warning is a visual warning.

11. A method of monitoring a network having a first device and a second device, comprising:
receiving a control packet sent from the first device to the second device;
receiving a response to the control packet sent from the second device to the first device; and
in the event that the control packet is not received from the first device or the response is not received from the second device within a predetermined time period, the method comprises:
measuring a characteristic of the control packet from the first device and the control packet from the second device;
comparing these characteristics to a property of the configuration of at least one of the network, first device, or second device; and
performing a predetermined event.

12. A method according to clause 11, wherein a characteristic of the control packet is the time at which the control packet was transmitted and/or received.

13. A method according to clause 11 or 12 wherein control packets are ARP or IGMP packets.

14. A method according to clause 13 where those known parameters of the system are timeout events/periods.

15. A computer program product comprising computer readable instructions which, when loaded onto a computer, configures the computer to perform a method according to any one of the preceding clauses.

16. A device for monitoring a network having a first and second device, comprising:
circuitry configured to:
receive IP packets containing media content from the first device on the network, the IP packets being sent to the second device;
analyse the received IP packets to determine a parameter of the media content;
analyse the parameter of the media content and a parameter associated with the second device;
wherein in the event that the parameter of the media content is different to the parameter associated with the second device, the circuitry is configured to:
compare these parameters to a property of the configuration of at least one of the network, first device or second device and
perform a predetermined action.

17. A device according to clause 16, wherein the parameter of the media content is the frame rate and/or resolution and/or bit depth and/or chroma format of the media content.

18. A device according to clause 16, wherein the parameter of the media content is the bandwidth of the media content.

19. A device according to clause 16, wherein the parameter is the destination of a video component, audio component and metadata component of the media content all being the second device.

20. A device according to any one of clauses 16 to 19, wherein the predetermined action is to provide a message to a user.

21. A device according to clause 20, wherein the message is a warning or a recommendation.

22. A device according to clause 20 or 21, wherein the recommendation is a new configuration of at least one of the network, first device or second device.

23. A device according to any one of clauses 16 to 19, wherein the predetermined action is to apply a new configuration to at least one of the network, first device or second device automatically.

24. A device for monitoring a network having a first device and a second device, comprising:
circuitry configured to:
receive IP packets containing control data being transmitted on the network;
analyse the received IP packets to determine the source of the IP packets; and
in the event that the source of the IP packets is not a media device, the method comprises:
determine the latency of the IP packets; and in the event that the latency is above a threshold latency, the circuitry is configured to:
provide a warning to the user.

25. A device according to clause 24, wherein the warning is a visual warning.

26. A device for monitoring a network having a first device and a second device, comprising:

circuitry configured to:
receive a control packet sent from the first device to the second device;
receive a response to the control packet sent from the second device to the first device; and
in the event that the control packet is not received from the first device or response is not received from the second device within a predetermined time period, the circuitry is configured to:
measure the characteristics of the control packet from the first device and the control packet from the second device;
compare the characteristics to known properties of the configuration of at least one of the network, first device, and second device; and
perform a predetermined event.

27. A device according to clause 26 wherein characteristics of the control packets are the times at which they were transmitted and/or received

28. A device according to clause 26 wherein control packets are ARP or IGMP packets.

29. A device according to clause 28 where those known parameters of the system are timeout events/periods.

1. A method of monitoring a network having a first and second device, the method comprising:
receiving IP packets containing media content from the first device on the network, the IP packets being sent to the second device;
analysing the received IP packets to determine a parameter of the media content; and
analysing the parameter of the media content and a parameter associated with the second device,
wherein in the event that the parameter of the media content is different to the parameter associated with the second device, the method comprises:
comparing the parameters to a property of the configuration of at least one of the network, the first device, or the second device; and
performing a predetermined action, wherein the predetermined action is to provide a message to a user, the message being a warning or a recommendation.

2. The method according to claim 1, wherein the parameter of the media content is a frame rate and/or a resolution and/or a bit depth and/or a chroma format of the media content.

3. The method according to claim 1, wherein the parameter of the media content is a bandwidth of the media content.

4. The method according to claim 1, wherein the parameter is a destination of a video component, audio component and metadata component of the media content all being the second device.

5-6. (canceled)

7. The method according to claim 1, wherein the recommendation is a new configuration of at least one of the network, the first device, or the second device.

8. The method according to claim 1, wherein the predetermined action is to apply a new configuration to at least one of the network, the first device, or the second device automatically.

9. A method of monitoring a network having a first device and a second device, comprising:
receiving IP packets containing control data being transmitted on the network;
analysing the received IP packets to determine a source of the IP packets;
in the event that the source of the IP packets is not a media device, determining the latency of the IP packets; and
in the event that the latency is above a threshold latency, providing a warning to the user.

10. The method according to claim 9, wherein the warning is a visual warning.

11. A method of monitoring a network having a first device and a second device, the method comprising:
receiving a control packet sent from the first device to the second device;
receiving a response to the control packet sent from the second device to the first device; and
in the event that the control packet is not received from the first device or the response is not received from the second device within a predetermined time period, the method comprises:
measuring a characteristic of the control packet from the first device and the control packet from the second device;
comparing these characteristics to a property of the configuration of at least one of the network, the first device, or the second device; and
performing a predetermined event.

12. The method according to claim 11, wherein a characteristic of the control packet is a time at which the control packet was transmitted and/or received.

13. The method according to claim 11, wherein the control packet is an ARP packet or an IGMP packet.

14. The method according to claim 11, wherein known parameters of the system are timeout events/periods.

15. A computer program product comprising a non-transitory computer readable medium storing instructions which, when loaded onto a computer, configures the computer to perform a method according to claim 1.

16. A device for monitoring a network having a first and second device, comprising:
circuitry configured to:
receive IP packets containing media content from the first device on the network, the IP packets being sent to the second device;
analyse the received IP packets to determine a parameter of the media content; and
analyse the parameter of the media content and a parameter associated with the second device,
wherein in the event that the parameter of the media content is different to the parameter associated with the second device, the circuitry is configured to:
compare these parameters to a property of the configuration of at least one of the network, the first device, or the second device, and
perform a predetermined action.

17. The device according to claim 16, wherein the parameter of the media content is a frame rate and/or a resolution and/or a bit depth and/or a chroma format of the media content.

18. The device according to claim 16, wherein the parameter of the media content is a bandwidth of the media content.

19. The device according to claim 16, wherein the parameter is a destination of a video component, audio component and metadata component of the media content all being the second device.

20. The device according to claim 16, wherein the predetermined action is to provide a message to a user.

21. The device according to claim 20, wherein the message is a warning or a recommendation.

22-23. (canceled)

24. A device for monitoring a network having a first device and a second device, comprising:
circuitry configured to:
receive IP packets containing control data being transmitted on the network;
analyse the received IP packets to determine the source of the IP packets;
in the event that the source of the IP packets is not a media device, determine the latency of the IP packets; and
in the event that the latency is above a threshold latency, provide a warning to the user.

25-29. (canceled)
